(19) United States
(12) Patent Application Publication
(10) Pub. No.: US 2008/0268842 A1
(43) Pub. Date: Oct. 30, 2008

(54) SYSTEM AND METHOD FOR UTILIZING A TEMPORARY USER IDENTITY IN A TELECOMMUNICATIONS SYSTEM

(76) Inventor: Christian Herrero-Veron, Lund (SE)

Correspondence Address: ERICSSON INC., 6300 LEGACY DRIVE, M/S EVR 1-C-11, PLANO, TX, 75024, US

(21) Appl. No.: 12/110,561

(22) Filed: Apr. 28, 2008

Related U.S. Application Data
(60) Provisional application No. 60/914,985, filed on Apr. 30, 2007.

(51) Int. Cl. H04Q 7/20; H04M 1/00

(52) U.S. Cl. 455/435.1; 455/561

(57) ABSTRACT

A system and method for allocating an S-TMSI in a telecommunication system. The System includes a UE operating within a tracking area of a Public Land Mobile Network. A Mobility Management Entity controls allocation of the S-TMSI to the UE. The S-TMSI has a 32-bit structure with a discriminator for discriminating Circuit Switched, CS, services and Packet Switched, PS, services utilized by the UE. The discriminator utilizes the two significant bits to indicate the CS or PS services.

### CROSS-REFERENCE TO RELATED APPLICATIONS

This application claims the benefit of U.S. Provisional Application No. 60/914,985, filed Apr. 30, 2007, the disclosure of which is incorporated herein by reference.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

The present invention relates to communications network. More particularly, and not by way of limitation, the present invention is directed to a system and method for utilizing a temporary user identity in a telecommunications system.

3rd Generation Partnership Project (3GPP) systems currently utilize temporary user identities in order to prevent the compromise of the subscriber's permanent identity, the International Mobile Subscriber Identity (IMSI). There are specific situations where the IMSI is utilized, but in most instances, the temporary identity is used. Currently, the identification of a particular user in the PS domain is achieved by a Packet Temporary Mobile Subscriber Identity (P-TMSI). The P-TMSI provides a unique identifier protecting the confidentiality and identity of the user. The P-TMSI is used to avoid compromising the IMSI for the identification for a specific user. The P-TMSI is utilized in a similar fashion as the TMSI for the Circuit Switched (CS) domain.

A particular P-TMSI only has significance in a Routing Area Identity (RAI) in which the user is registered. Therefore, the P-TMSI is issued to a PS-domain enabled mobile station (MS). This P-TMSI is unique within a specific RAI and used by the network to page a particular MS. The P-TMSI includes 32 bits which is associated with a Temporary Logical Link Identifier (TLLI) in A/Gb mode. The network may assign a P-TMSI signature to an MS in an attach, routing area update, or P-TMSI reallocation procedure. In combination with a valid P-TMSI, this P-TMSI signature is used by the MS for authentication and identification purposes in the subsequent attach, routing area update or detach procedure. If the MS has no valid P-TMSI, it does not use the P-TMSI signature in the subsequent attach, routing area update or detach procedure. Upon successful completion of the subsequent attach or routing area update procedure, the used P-TMSI signature is deleted. Upon completion of an MS initiated detach procedure, the used P-TMSI signature is deleted.

The allocation by the network of a P-TMSI may occur at any time. This may be performed during the attach or routing area updating procedures. In addition, a specific P-TMSI reallocation procedure exists.

For Evolved Universal Terrestrial Radio Access (E-UTRA), 3GPP TS 23.401 states that a temporary user identity is used, called an S-Temporary Mobile Subscriber Identity (S-TMSI). The S-TMSI is allocated during the attach and tracking area updating procedures. 3GPP TR 23.882 states that the S-TMSI is unique within a tracking area or within an MME pool area. Therefore, the S-TMSI is similar to the P-TMSI utilized in current 3GPP systems. However, currently the S-TMSI shares TMSI space with the CS domain, thereby providing an inefficient use of network resources. In addition, 3GPP TS 23.401 states that the MME allocates a Globally Unique Temporary Identity (GUTI) to the UE. The GUTI has two main components: one that uniquely identifies the MME which allocated the GUTI; and one that uniquely identifies the UE within the MME that allocated the GUTI. Within the MME, the mobile station is identified by a Mobile TMSI (M-TMSI). The Globally Unique MME Identifier (GUMMEI) is constructed from MCC, MNC and MME Identifier (MMEI). In turn, the MMEI is constructed from an MME Group ID (MMEGI) and an MME Code (MMEC). The GUTI is constructed from the GUMMEI and the M-TMSI. For paging, the mobile station is paged with the S-TMSI. The S-TMSI is constructed from the MMEC and the M-TMSI. The operator must ensure that the MMEC is unique within the MME pool area and, if overlapping pool areas are in use, unique within the area of overlapping MME pools. The GUTI is used to support subscriber identity confidentiality, and, in the shortened S-TMSI form, to enable more efficient radio signalling procedures (e.g. paging and Service Request).

### BRIEF SUMMARY OF THE INVENTION

It would be advantageous to have a system and method for utilizing an S-TMSI with the same structure as the P-TMSI and allocated uniquely in the MME or MME pool that overcomes the disadvantages of the prior art. The present invention provides such a system and method. The present invention is a system and method for allocating an S-TMSI with the same structure as the P-TMSI and associated uniquely with the MME or MME pool. Thus, in one aspect, the present invention is directed to a telecommunication system for allocating an S-TMSI. The System includes a User Equipment, UE, operating within a tracking area of a Public Land Mobile Network. A Mobility Management Entity controls allocation of the S-TMSI to the UE. The S-TMSI has a 32-bit structure with a discriminator for discriminating Circuit Switched, CS, services and Packet Switched, PS, services utilized by the UE. Preferably, the discriminator utilizes the two significant bits to indicate the CS or PS services.

In another aspect, the present invention is directed to a method of allocating an S-TMSI within a telecommunication system. The method includes the steps of allocating by an MME a first S-TMSI to a UE and receiving the first S-TMSI by the UE for use within a tracking area. The S-TMSI has a discriminator for discriminating Circuit Switched, CS, services and Packet Switched, PS, services utilized by the UE. When the UE enters another tracking area, the MME reallocates a second S-TMSI to the UE by sending a first message with the second S-TMSI to the UE. Upon receiving the first message by the UE, the UE validates the second S-TMSI and invalidates the first S-TMSI. The UE then sends a second message to the MME acknowledging the first message. The MME, upon receiving the second message, invalidates the first S-TMSI.

In yet another aspect, the present invention is directed to a node for allocating an S-TMSI within a telecommunication system. The node allocates the S-TMSI to a UE operating within a tracking area of a Public Land Mobile Network. The node determines when the UE is operating within the tracking area. In addition, the S-TMSI has a discriminator for discriminating Circuit Switched, CS, services and Packet Switched, PS, services utilized by the UE.

### BRIEF DESCRIPTION OF THE SEVERAL VIEWS OF THE DRAWING

In the following section, the invention will be described with reference to exemplary embodiments illustrated in the figures, in which:

FIG. 1 is a diagram of an exemplary S-TMSI utilized in the preferred embodiment of the present invention;

FIG. 2 is a block diagram of a telecommunications system in one embodiment of the present invention;

FIG. 3 is a signalling diagram illustrating the messages for reallocating a S-TMSI in one embodiment of the present invention; and

FIG. 4 is a flowchart illustrating the steps of allocating the S-TMSI within the telecommunications system according to the teachings of the present invention.

### DETAILED DESCRIPTION OF THE INVENTION

The present invention is a system and method for utilizing a temporary user identity in a telecommunications system. As discussed above, the TMSI has only local significance (i.e. within a Visitor Location Register (VLR) and the area controlled by a VLR, or within an Serving GPRS Support Node (SGSN) and the area controlled by an SGSN). The structure and coding of the TMSI may be chosen by agreement between operator and manufacturer in order to meet local needs. The P-TMSI consists of 4 octets. It can be coded using a full hexadecimal representation. In areas where both Mobile Switching Center (MSC)-based services and SGSN-based services are provided, some form of discrimination is required between the allocation of TMSIs for MSC-based services and the allocation of TMSIs for SGSN-based services, The discrimination is provided by the two most significant bits, with values 00, 01, and 10 being used by the VLR, and 11 being used by the SGSN.

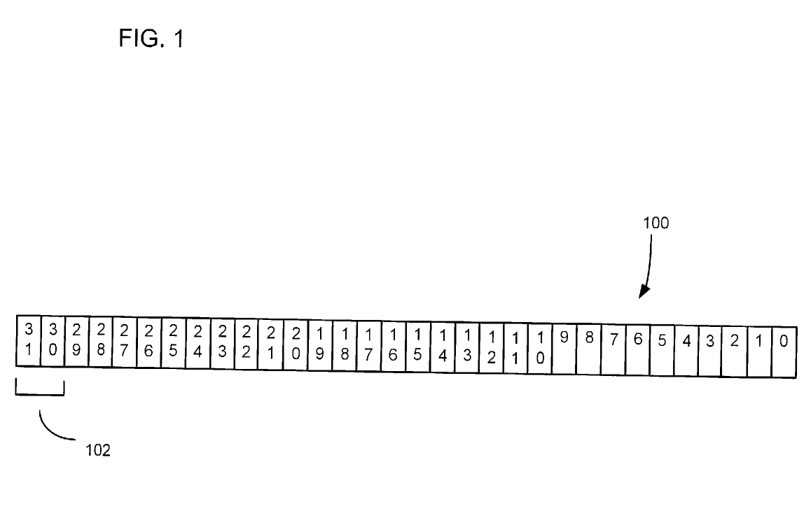

In the present invention, the S-TMSI may be structured in a similar manner as the P-TMSI. FIG. 1 is a diagram of an exemplary S-TMSI 100 utilized in the preferred embodiment of the present invention. The S-TMSI includes a 4 octets (32 bits) structure. In one embodiment, the discriminating coding is a Circuit Switched (CS)/Packet Switched (PS) field 102 that occupies the two most significant bits of the S-TMSI structure. In the CS/PS field 102, specific values may be used to indicate that the TMSI 100 is associated with CS-based services while other designated values may be used to indicate that the TMSI 100 is associated with PS-based services. Of course, in other systems, the CS/PS field may be encoded in other ways. Furthermore, the CS/PS field need not be located in the most significant portion of the TMSI, nor does it have to be two-bits wide.

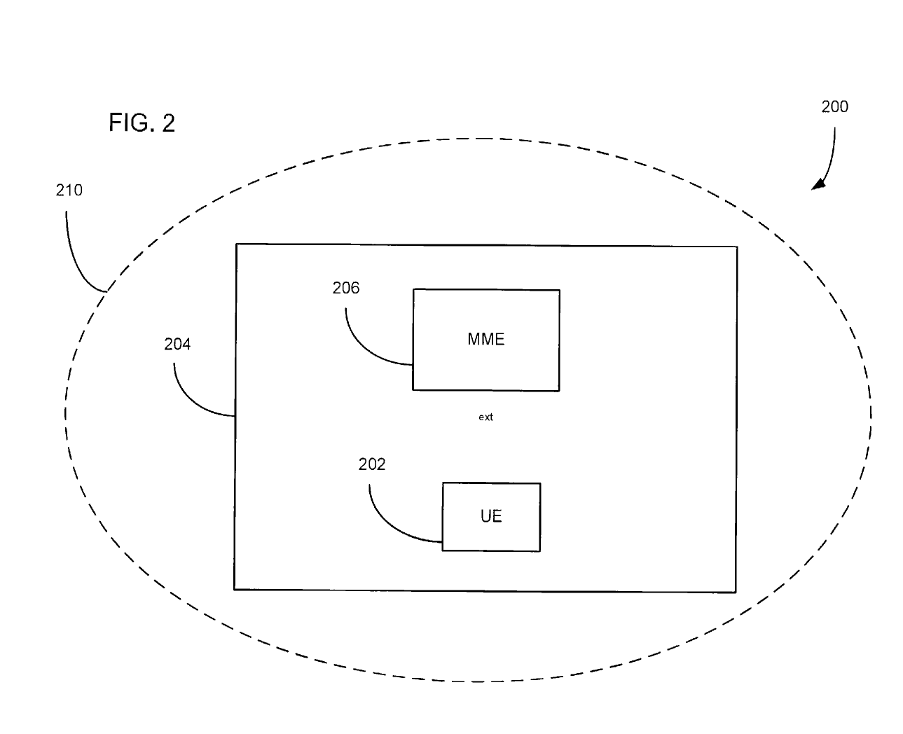

FIG. 2 is a block diagram of a telecommunications system 200 in one embodiment of the present invention. One or more User Equipment (UE) 202 capable of Evolved Universal Terrestrial Radio Access (E-UTRA) operates within a tracking area 204. A mobility management entity (MME) 206 is response for allocating the S-TMSI to the UE 202. The MME provides control functions within the tracking area 204. In other embodiments, the MME provides coverage within a MME pool. The telecommunications system is utilized within a Public Land Mobile Network (PLMN) 210.

Preferably, the S-TMSI does not need to be unique within the PLMN. A Network Resource Identifier (NRI) field may be re-used in the case where two MME pools do not overlap. Within the core-network, a Tracking Area Identity (TAI) and the NRI field may be used for routing and finding UE-related contexts. The TAI is the identity used to identify tracking areas. The Tracking Area Identity is constructed from the MCC (Mobile Country Code), MNC (Mobile Network Code) and TAC (Tracking Area Code).

In one embodiment, the S-TMSI is not extended with TAI information. Currently, S-TMSI per MME or MME pool allocation does not result in a problem with regards to limiting the number of UEs that can be supported in a MME pool area. Thus, in this embodiment, the 32-bit long S-TMSI allows a very large number of UEs. Furthermore, the case of S-TMSI allocation unique in multi-TA list areas in which the S-TMSI is re-used within the pool may be supported as an implementation option. The allocation of S-TMSI per MME or MME pool allows reusing current paging and other mobility management procedures. However, in an alternate embodiment of the present invention, the S-TMSI may be extended with TAI information. In addition, the S-TMSI is operable within legacy systems.

For E-UTRA, the concept of a list of tracking areas exists and identifies the tracking area identities which the UE can enter without the need for performing a tracking area updating procedure.

As a temporary user identity for E-UTRA based services, the S-TMSI may be used for identification within the signaling procedures. In one embodiment, the S-TMSI has significance only within one or more tracking areas identified by a list of tracking areas. Outside the list of tracking areas, the S-TMSI has to be combined with more information, e.g., the Tracking Area Identity (TAI), in order to provide for a globally unambiguous identity. However, the S-TMSI by itself provides for unambiguous identity within the MME which has allocated it and the MME pool.

The MME is responsible for allocating the S-TMSI to the UE. The allocation of the S-TMSI may be performed during attach, tracking area updating and S-TMSI reallocation procedures. In addition, the MME uses the S-TMSI for paging purposes. The UE, capable of E-UTRA, includes a valid S-TMSI at attach, during tracking area updating and service request procedures. The MME may assign a new S-TMSI for a particular UE for successful attach and tracking area updating procedures. Also, the MME may assign a new S-TMSI via using standalone S-TMSI reallocation procedure. The S-TMSI may be provided together with a list of tracking areas.

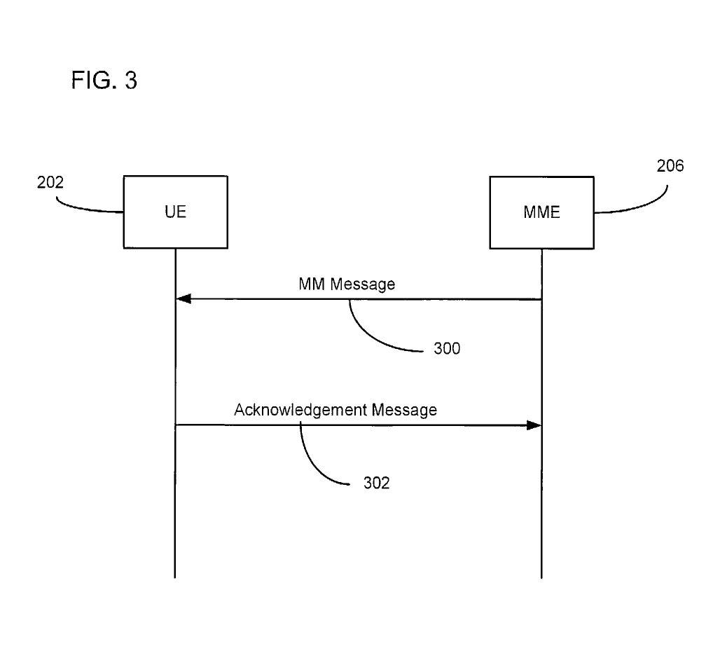

FIG. 3 is a signalling diagram illustrating the messages for reallocating an S-TMSI in one embodiment of the present invention. If a new S-TMSI is assigned by the MME, the UE and the MME provide the following messages. The UE receives a Mobility Management (MM) message 300 containing a new S-TMSI from the MME. The UE considers the new S-TMSI as valid, and it also provides a new list of tracking areas as valid. The UE then considers the old S-TMSI and old list of tracking areas as invalid. Next, the UE sends an acknowledge message 302 to the MME acknowledging the MM message and change of S-TMSI and list of tracking areas. The MME considers the old S-TMSI and old list of tracking areas as invalid as soon as an acknowledge message for an attach, tracking area updating or S-TMSI reallocation procedure is received.

The purpose of the S-TMSI reallocation procedure described in FIG. 3 is to provide identity confidentiality, i.e., to protect a user from being identified and located by an intruder. The S-TMSI reallocation is preferably performed at least when the UE changes a tracking area. In addition, for inter-operability within legacy 3GPP systems (e.g., GERAN/UTRAN), one of the TAI on the list of tracking areas in conjunction with the S-TMSI is preferably used for identifying the UE towards a legacy 3GPP system (e.g., finding UE-related contexts). For exemplary purposes, it can be considered the use of the first TAI on the list of tracking areas.

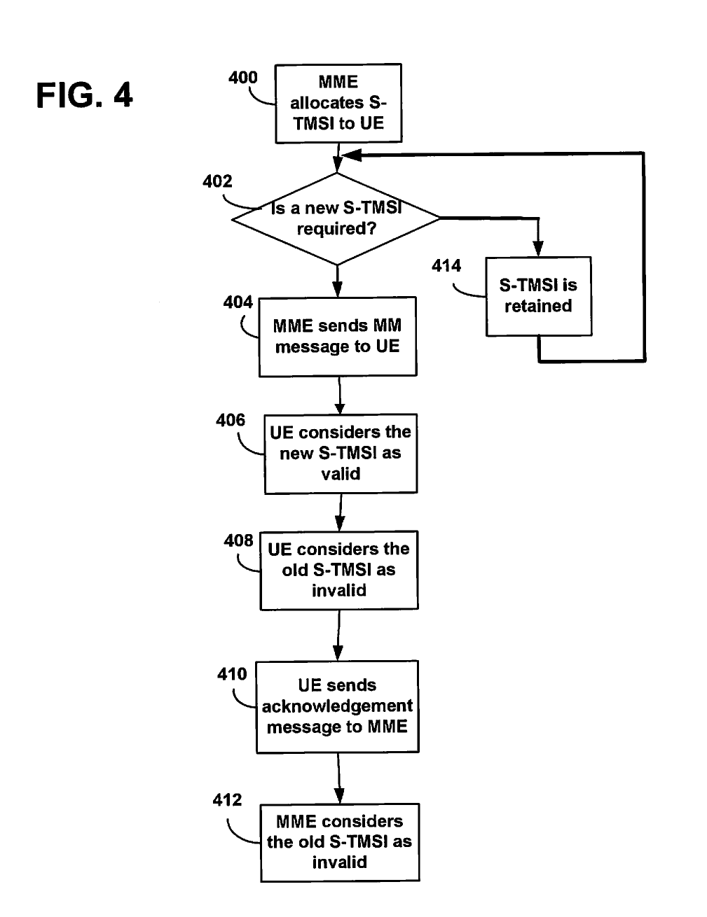

FIG. 4 is a flowchart illustrating the steps of allocating the S-TMSI 100 within the telecommunications system 200 according to the teachings of the present invention. With reference to FIGS. 1-4, the method of allocating the S-TMSI 100 will now be explained. In step 400, the MME 206 allocates the S-TMSI 100 to the UE located within the tracking area 204. The S-TMSI preferably includes a 32 bit structure. In one embodiment, the discriminating coding in the Circuit Switched (CS)/Packet Switched (PS) field 102, which occupies the two most significant bits of the S-TMSI structure provides an indicator of the type of services (i.e., CS or PS services). In the CS/PS field 102, specific values may be used to indicate that the TMSI 100 is associated with CS-based services while other designated values may be used to indicate that the TMSI 100 is associated with PS-based services. The TMSI 100 is allocated to the UE during attach, tracking area update or reallocation. Preferably, the S-TMSI 100 has the same structure as the P-TMSI. The S-TMSI does no need to be unique within the PLMN 210, but rather is allocated uniquely in the MME or MME pool. Next, in step 402, it is determined if a new S-TMSI must be allocated to the UE 202. If it is determined that the UE requires a new S-TMSI, the MME sends an MM message 300 containing a new S-TMSI to the UE in step 404. Next, in step 406, the UE 202 considers the new S-TMSI and new list of tracking areas as valid. In step 408, the UE then considers the old S-TMSI and old list of tracking areas as invalid. The UE then sends an acknowledge message 302 to the MME 206 acknowledging the MM message and change of S-TMSI and list of tracking areas in step 410. In step 412, the MME considers the old S-TMSI and old list of tracking areas as invalid as soon as an acknowledge message for an attach, tracking area updating or S-TMSI reallocation procedure is received. However, in step 402, if it is determined that the new S-TMSI is not required, the UE retains the same S-TMSI in step 414. Next, the method returns to step 402 where it is determined if a new S-TMSI is required.

Thus, the present invention provides an S-TMSI having a structure similar to a P-TMSI Specifically, the S-TMSI utilizes the two most significant bits to discrimination between the allocation of TMSI for CS-domain based services and PS-domain based services. In addition, the S-TMSI does not need to be unique within the PLMIN, but allocated uniquely in the MME or MME pool. Additionally, the S-TMSI may be useable in legacy 3GPP systems.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A telecommunication system for allocating an S-Temporary Mobile Subscriber Identity, S-TMSI, the system comprising:
a User Equipment, UE, operating within a tracking area of a Public Land Mobile Network;
a Mobility Management Entity, MME, controlling allocation of the S-TMSI to the UE;
wherein the S-TMSI has a discriminator for discriminating Circuit Switched, CS, services and Packet Switched, PS, services utilized by the UE.

2. The telecommunication system as recited in claim 1 wherein the S-TMSI has a 32-bit structure.

3. The telecommunication system as recited in claim 2 wherein the S-TMSI has a structure similar to a Packet Temporary Mobile Subscriber Identity, P-TMSI, structure.

4. The telecommunication system as recited in claim 2 wherein the discriminator is provided in two most significant bits of the 32-bit structure.

5. The telecommunication system as recited in claim 1 wherein the UE is capable of Evolved Universal Terrestrial Radio Access, E-UTRA.

6. The telecommunication system as recited in claim 1 wherein the MME reallocates a new S-TMSI to the UE when the UE enters a second tracking area.

7. The telecommunication system as recited in claim 1 wherein the S-TMSI is not unique within the PLMN.

8. The telecommunication system as recited in claim 1 wherein:
the UE is capable of E-UTRA and includes a valid S-TMSI at attach, during tracking area updating and service request procedures; and
the UE sends a tracking area identity included in a list of tracking areas stored in the UE with the S-TMSI.

9. The telecommunication system as recited in claim 1 wherein the MME allocates the S-TMSI based on the coverage of the MME or an MME pool.

10. The telecommunication system as recited in claim 1 wherein the S-TMSI is not extended with Tracking Area Identity information.

11. The telecommunication system as recited in claim 1 wherein the S-TMSI is operable within legacy systems.

12. The telecommunication system as recited in claim 1 wherein the S-TMSI has significance within the tracking area identified by a list of tracking areas stored within the MME.

13. The telecommunication system as recited in claim 1 wherein the MME allocates the S-TMSI during attach, tracking area updating or S-TMSI reallocation.

14. The telecommunication system as recited in claim 12 wherein:
the MME allocates a list of tracking areas together with the S-TMSI by means of a S-TMSI reallocation procedure; and
the UE sends, together with the S-TMSI, a tracking area identity included in the list of tracking areas stored in the UE.

15. A method of allocating an S-Temporary Mobile Subscriber Identity, S-TMSI, within a telecommunication system, the method comprising the steps of:
allocating, by a Mobility Management Entity, MME, a first S-TMSI to a User Equipment, UE, wherein the S-TMSI has a discriminator for discriminating Circuit Switched, CS, services and Packet Switched, PS, services utilized by the UE; and
receiving the first S-TMSI by the UE for use within a first tracking area.

16. The method as recited in claim 15 wherein the S-TMSI has a 32-bit structure.

17. The method as recited in claim 16 wherein the discriminator is provided in two most significant bits of the 32-bit structure.

18. The method as recited in claim 15 further comprising the step of reallocating a second S-TMSI to the UE when the UE enters a second tracking area.

19. The method as recited in claim 18 wherein the step of reallocating a second S-TMSI includes the steps of:
sending a first message with the second S-TMSI to the UE by the MME;
upon receiving the first message by the UE, validating the second S-TMSI and invalidating the first S-TMSI;
sending a second message to the MME acknowledging the first message; and
upon receiving the second message, the MME invalidating the first S-TMSI.

20. The method as recited in claim 15 wherein the MME allocates the first S-TMSI based on the coverage of the MME or an MME pool.

21. The method as recited in claim 15 wherein the MME allocates the first S-TMSI during attach, tracking area updating or S-TMSI reallocation.

22. The method as recited in claim 15 wherein the UE is capable of E-UTRA and includes a valid S-TMSI at attach, during tracking area updating and service request procedures.

23. A node for allocating an S-Temporary Mobile Subscriber Identity, S-TMSI, within a telecommunication system, the node comprising:
means for allocating the S-TMSI to a User Equipment, UE, operating within a first tracking area of a Public Land Mobile Network; and
means for determining when the UE is operating within the first tracking area;
wherein the S-TMSI has a discriminator for discriminating Circuit Switched, CS, services and Packet Switched, PS, services utilized by the UE.

24. The node as recited in claim 23 wherein the node is a Mobility Management Entity.

25. The node as recited in claim 23 wherein the S-TMSI has a 32-bit structure.

26. The node as recited in claim 25 wherein the S-TMSI has a structure similar to a Packet Temporary Mobile Subscriber Identity, P-TMSI, structure.

27. The node as recited in claim 25 wherein the discriminator is provided in two most significant bits of the 32-bit structure.

28. The node as recited in claim 23 wherein the node reallocates a new S-TMSI to the UE when the UE enters a second tracking area.

29. The node as recited in claim 23 wherein the node allocates the S-TMSI based on the coverage of the node.

30. The node as recited in claim 23 wherein the node allocates the S-TMSI during attach, tracking area updating or S-TMSI reallocation.

31. A User Equipment, UE, utilizing an S-Temporary Mobile Subscriber Identity, S-TMSI, within a telecommunication system, the node comprising:
means for utilizing the S-TMSI while operating within a first tracking area of a Public Land Mobile Network; and
means for determining when the UE is operating within the first tracking area;
wherein the S-TMSI has a discriminator for discriminating Circuit Switched, CS, services and Packet Switched, PS, services utilized by the UE.

32. The UE as recited in claim 31 wherein the S-TMSI has a 32-bit structure.

33. The UE as recited in claim 32 wherein the S-TMSI has a structure similar to a Packet Temporary Mobile Subscriber Identity, P-TMSI, structure.

34. The UE as recited in claim 32 wherein the discriminator is provided in two most significant bits of the 32-bit structure.

35. The UE as recited in claim 31 wherein the UE utilizes a new S-TMSI when the UE enters a second tracking area.

36. The UE as recited in claim 31 wherein the UE is capable of E-UTRA and includes a valid S-TMSI during attach, tracking area updating or S-TMSI reallocation.

37. The UE as recited in claim 36 wherein the UE sends a tracking area identity included in a list of tracking areas stored in the UE with the S-TMSI.
